(19) United States
(12) Patent Application Publication
(10) Pub. No.: US 2003/0202768 A1
(43) Pub. Date: Oct. 30, 2003

(54) High density optical fiber array

(76) Inventors: Steven Nasiri, Saratoga, CA (US); Zhenfang Chen, Sunnyvale, CA (US); Lay Lay Lee-Aquila, Newark, CA (US); James H. Smith, Campbell, CA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/431,042

(22) Filed: May 6, 2003

Related U.S. Application Data
(63) Continuation of application No. 09/866,063, filed on May 25, 2001, now abandoned.

(51) Int. Cl. G02B 6/00

(52) U.S. Cl. 385/137

(57) ABSTRACT

An optical fiber array in accordance with an embodiment of the present invention includes a housing, a first plate through which pass a first plurality of holes distributed in a first pattern, and a silicon plate through which pass a second plurality of holes distributed in a second pattern. The first plate is attached to the housing and the silicon plate is attached to the first plate such that each of the second plurality of holes is substantially aligned with a corresponding one of the first plurality of holes. The optical fiber array also includes a plurality of optical fibers, each of which passes through a corresponding one of the first plurality of holes and extends into a corresponding one of the second plurality of holes.

### BACKGROUND OF THE INVENTION

1. Field of the Invention

The present invention relates to optical fibers. More particularly, the present invention relates to optical fiber arrays.

2. Description of the Related Art

Optical fiber networks such as telecommunication networks typically include optical fiber arrays coupled to other optical devices such as, for example, optical fiber switches and other optical fiber array cross connects.

Light emitted from an optical fiber typically diverges in a cone-shaped pattern determined by the numerical aperture (NA) of the optical fiber. (NA=nsin(θₘₐₓ), where n is the refractive index of the medium into which the fiber emits light and θₘₐₓ is the half angle of the cone shaped emission pattern.) To minimize loss when connecting an optical fiber array to an optical system, the diverging light beams emitted by the optical fibers in the array are typically collimated and/or refocused by lenses. Simultaneously collimating and/or refocusing light beams emitted by the multiple fibers of an optical fiber array to efficiently couple the emitted light into another optical system typically requires that each of the individual optical fibers is aligned to ensure that 1) light is emitted from each optical fiber at a precisely known position within the array, 2) light is emitted from each optical fiber at substantially the same angle (i.e., the optical fibers are aligned substantially parallel to each other), 3) light is emitted from each optical fiber at substantially the same distance from the collimating and/or refocusing lenses, and 4) each optical fiber has substantially the same numerical aperture.

Known precision optical fiber arrays such as, for example, the v-groove optical fiber array disclosed in U.S. Pat. No. 6,027,253 typically include a small number of optical fibers (e.g. up to about 64) arranged in parallel in a single plane. Such single-plane arrays rapidly become unwieldy as the number of optical fibers they include increases. Many applications in telecommunications, for example, are expected to require optical fiber arrays including more than one hundred (perhaps more than one thousand) optical fibers. Unfortunately, single-plane arrays are impractical for such applications. Moreover, efficiently coupling light output by an optical fiber array into another optical system becomes more difficult when aligning very large quantities of optical fibers than when dealing with only a few optical fibers.

What is needed is an optical fiber array including a large number of optical fibers which may be efficiently optically coupled to another optical device or optical system.

### SUMMARY OF THE INVENTION

An optical fiber array in accordance with the present invention includes a housing, a first plate through which pass a first plurality of holes distributed in a first pattern, and a silicon plate through which pass a second plurality of holes distributed in a second pattern. The first plate is attached to the housing and the silicon plate is attached to the first plate such that each of the second plurality of holes is substantially aligned with a corresponding one of the first plurality of holes. The optical fiber array also includes a plurality of optical fibers, each of which passes through a corresponding one of the first plurality of holes and extends into a corresponding one of the second plurality of holes.

In one embodiment, the housing is fabricated from a stainless steel and the first plate is fabricated from an invar alloy. The first plate may be attached to the housing by brazing, for example. The silicon plate may be attached to the first plate with a layer of a soldering material such as indium, for example, which adheres to the first plate and to a metal layer disposed on the silicon plate. The soldering material may form a hermetic seal between the optical fibers and the silicon plate. The holes in the silicon plate may be fabricated, for example, by a combination of deep reactive ion etching (DRIE) and etching with potassium hydroxide. In one implementation, the optical fibers are assembled into a plurality of substantially planar arrays prior to being inserted into the housing, through the first plurality of holes, and into the second plurality of holes.

In another aspect of the present invention, a silicon plate suitable for use in an optical fiber array in accordance with the present invention has a first surface and a second surface. Side walls of the holes in the silicon plate have first portions near the first surface and second portions near the second surface. The first portions of the side walls are substantially parallel to each other. The second portions of the side walls form chamfered openings in the second surface of the silicon plate. In one embodiment, the silicon plate has a thickness of greater than about 0.5 millimeters and the first portions of the side walls form substantially cylindrical channels. Advantageously, stripped portions of optical fibers may be easily inserted into the chamfered openings in the silicon plate and self-guided into the cylindrical channels. Moreover, the positions of optical fibers inserted into the silicon plate may be known to a precision of better than about ±1 μm, and the orientations of the optical fibers may be maintained within about 1 milliradian of parallel.

In another aspect of the present invention, a single-plane array of optical fibers suitable for use in an optical fiber array in accordance with the present invention includes a plurality of optical fibers each having a first portion and a second portion. The single-plane array also includes an encapsulating material such as, for example, a polyimide film or tape. The first portions of the optical fibers are encapsulated in the encapsulating material to form a sheet in which the first portions are substantially equally spaced and substantially parallel. The second portions of the optical fibers are encapsulated in the encapsulating material to form a plurality of ribbons each of which includes a subset of the second portions of the optical fibers. Such single-plane arrays may be easily handled. In particular, optical fibers in the sheet portion may be easily inserted into holes in the silicon plate described above. In addition, the plurality of ribbons may be easily spliced to standard optical fiber ribbons.

Optical fiber arrays in accordance with the present invention may be used to efficiently and reliably couple a large number of optical fibers to an optical system such as an optical switching fabric. This efficient coupling results in part from the precision with which the positions of the optical fibers in the array may be known. Also, the optical fibers in the optical fiber array may be arranged to emit light in substantially the same directions and thus facilitate efficient optical coupling. In addition, the optical fibers may be selected to have substantially the same numerical apertures. Hence, the emitted light can be efficiently collimated and/or refocused. An additional advantage of optical fiber arrays in accordance with some embodiments of the present invention is a hermetic seal formed between the optical fibers and a silicon plate during a solder reflow process. This hermetic seal may prevent moisture from entering an optical system or optical device to which the optical fiber array is coupled.

### BRIEF DESCRIPTION OF THE DRAWINGS

FIG. 1 is a schematic illustration of an optical fiber array in accordance with an embodiment of the present invention.

FIGS. 2A-2B are schematic illustrations of a single-plane optical fiber array to be included in an optical fiber array in accordance with an embodiment of the present invention.

FIGS. 3A-3C are, respectively, perspective, top, and side views of a metal housing included in an optical fiber array in accordance with an embodiment of the present invention.

FIGS. 4A-4B are, respectively, top and side views of a metal plate included in an optical fiber array in accordance with an embodiment of the present invention.

FIG. 5 is a schematic illustration of a patterned silicon wafer in accordance with an embodiment of the present invention.

FIG. 6 is a cross-sectional view of a portion of the silicon wafer of FIG. 5.

FIG. 7 is a flow chart illustrating a method of fabricating an optical fiber array in accordance with an embodiment of the present invention.

FIG. 8 is a perspective view of several components of an optical fiber array in accordance with an embodiment of the present invention and an alignment ring used in their assembly.

It should be noted that the dimensions in the figures are not necessarily to scale. Like reference numbers in the various figures denote like parts in the various embodiments.

### DETAILED DESCRIPTION

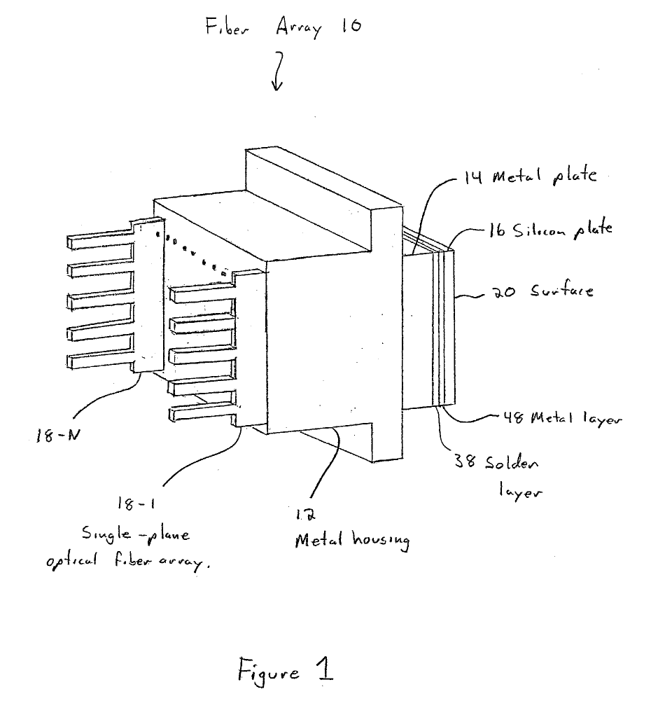

Referring to FIG. 1, in accordance with one embodiment of the present invention an optical fiber array 10 (also referred to herein as a fiber block assembly) includes a metal housing 12, a metal plate 14, a silicon plate 16, and a plurality of optical fibers arranged in N single-plane arrays such as single-plane arrays 18-1-18-N. Single-plane arrays 18-1-18-N are partially inserted into housing 12. Hence, portions of single-plane arrays 18-1-18-N inside housing 12 are not visible in FIG. 1. Although only two of single-plane arrays 18-1-18-N are explicitly shown in FIG. 1, in one embodiment optical fiber array 10 includes N=30 such single-plane arrays arranged substantially parallel to each other. In other embodiments N is either greater than or less than 30. As described below, portions of the optical fibers included in the single-plane arrays pass through holes in metal plate 14 and holes in silicon plate 16 to form a two-dimensional array of optical fibers at surface 20 of silicon plate 16.

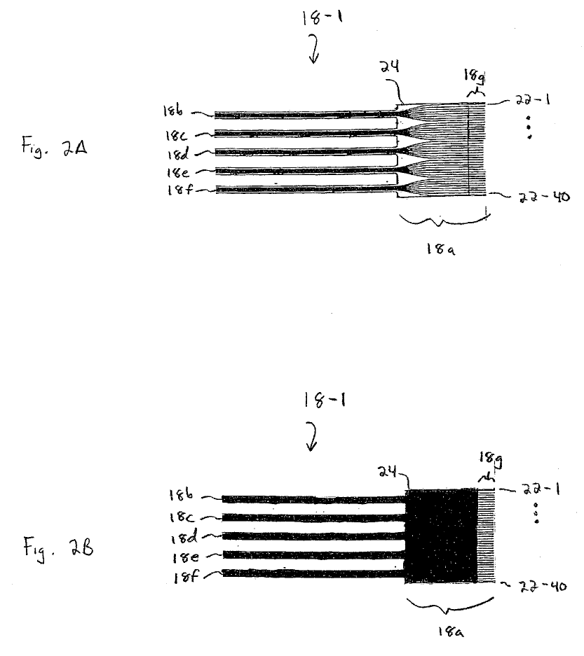

An example single-plane array 18-1 is shown in greater detail in FIGS. 2A and 2B. In the illustrated embodiment single-plane array 18-1 includes 40 optical fibers 22-1-22-40. In other embodiments, however, single-plane array 18-1 includes either more or fewer than 40 optical fibers. Optical fibers 22-1-22-40 are, for example, conventional Coming, Incorporated SMF-28 single-mode optical fibers having a core diameter of about 8.3 microns (μm) and a cladding diameter of about 125±1 μm. In one implementation optical fibers 22-1-22-40 are precision SMF-28 single-mode optical fibers having a cladding diameter of about 125±0.2 μm.

Optical fiber manufacturers are able to maintain good numerical aperture control within a single lot or spool of fiber, but reproducibility from lot to lot is not as good. Hence, optical fibers 22-1-22-40 are typically taken from the same spool of optical fiber to ensure that every optical fiber in the fiber block assembly has approximately the same numerical aperture. Typically, the numerical apertures of optical fibers 22-1-22-40 vary by less than about 10% from their average value. The optical fiber is also typically selected to have excellent concentricity of cladding and core so that the location of the optical fiber core may be precisely known. In one implementation, the typical core cladding concentricity is less than about ±1 μm. Since such highly concentric optical fiber is typically expensive, optical fibers 22-1-22-40 are typically relatively short (less than about 15 cm in length).

Optical fibers 22-1-22-40 are encapsulated in flexible tape 24, which maintains the positions of the optical fibers with respect to each other. Tape 24 is, for example, a conventional polyimide film or tape such as a commercially available Kapton® tape. Other materials suitable for ribbonizing optical fibers may also be used. For convenience of illustration, tape 24 is shown as transparent in FIG. 2A and as opaque in FIG. 2B.

In portion 18a of single-plane array 18-1 leading portions of optical fibers 22-1-22-40 are arranged substantially parallel to each other in a substantially planar flexible sheet with a separation of 1±0.1 millimeters (mm) between adjacent optical fibers (other separations may be used in other implementations). These leading portions of the optical fibers are subsequently partially inserted into metal housing 12 during assembly of fiber array 10. Typically, the spacing of the optical fibers in portion 18a of the single-plane array is selected to approximately match the spacing of arrays of holes in metal plate 14 and silicon plate 16. Such choice of spacing facilitates assembly of fiber array 10.

In portion 18g of single-plane array 18-1, tape 24 has been removed from (or, alternatively, was not applied to) the optical fibers. These free portions of optical fibers 22-1-22-40 may be inserted into metal plate 14 and silicon plate 16 after portions of the outer buffer layers of the optical fibers have been removed. In some implementations portions of the optical fibers to be inserted into holes in silicon plate 16 are metallized with gold, for example, using conventional metallization processes. Such metallization facilitates formation of a hermetic solder seal between the fibers and silicon plate 16 during a subsequent soldering process. Suitable optical fiber metallization processes are known to one of ordinary skill in the art. Trailing portions of optical fibers 22-1-22-40 are arranged as five conventional optical fiber ribbons 18b-18f each including eight optical fibers. Advantageously, these conventional optical fiber ribbons may be subsequently spliced to any type of single-mode, ribbonized optical fibers.

The precision with which optical fibers 22-1-22-40 are positioned in single-plane array 18 allows removal (stripping) of the cladding and buffer layers from all 40 optical fibers simultaneously. Consequently, handling (and risk of breakage) of the individual optical fibers is minimized. Moreover, the 40 optical fibers may be inserted into metal housing 12, metal plate 14, and silicon plate 16 as a group, thus reducing the complexity of the insertion step.

Single-plane array 18 may be manufactured, for example, using conventional ribbonizing apparatus typically used to produce ribbonized optical fiber back-plane technology. Such ribbonizing processes and apparatus are known to one of ordinary skill in the art. Numerous vendors can provide such ribbonizing services.

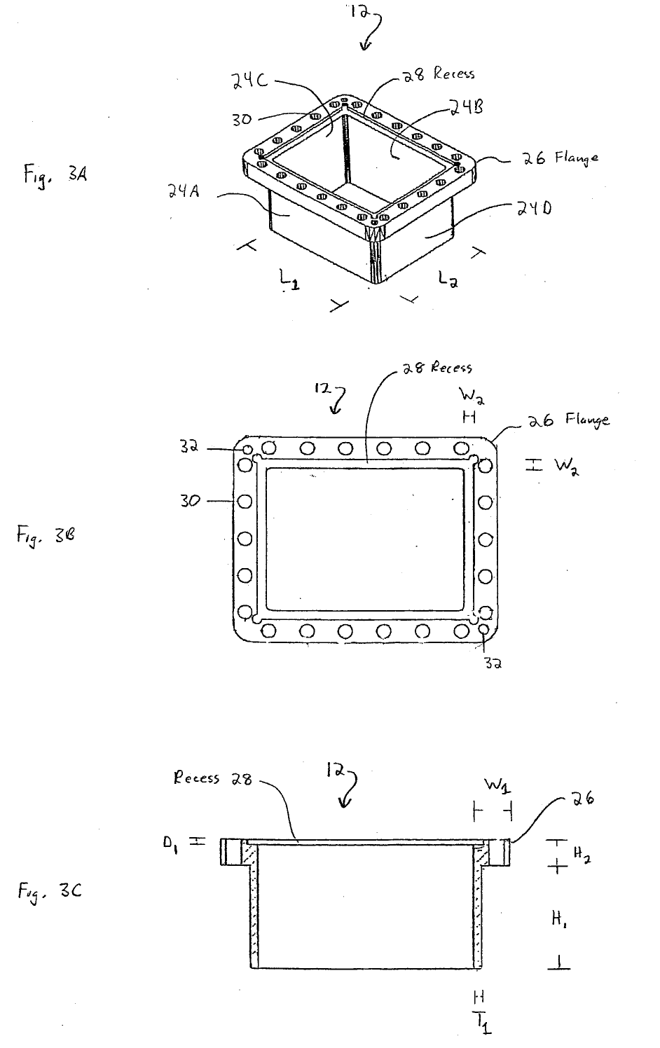

Metal housing 12, shown in greater detail in FIGS. 3A-3C, may be conventionally machined from stainless steel, for example. In the illustrated embodiment, metal housing 12 has a rectangular cross-section with sides 24A and 24B of length L₁=43.5 mm and sides 24C and 24D of length L₂=33.5 mm. All four sides are of height H₁=35.0 mm and thickness T₁=3.0 mm. Metal housing 12 also includes a flange 26 having a height of H₂=5.0 mm and a width of W₁=7.0 mm. Flange 26 includes a recess 28 having a depth of D₁=1.0 mm and a width of W₂=2.0 mm. Of course, other dimensions may also be used as appropriate. In the assembled optical fiber array 10 (FIG. 1), metal plate 14 is seated in recess 28 (FIGS. 3A-3C). A plurality of non-threaded holes 30 (only one of which is labeled) pass through flange 26, enabling optical fiber array 10 to be attached to another optical element or optical system with, for example, bolts, screws, or pins. In one embodiment, holes 30 are typically 3.0 mm in diameter and spaced at intervals of 8.0 mm along each edge of flange 26. Two non-threaded holes 32 pass through opposite corners of flange 26. Holes 32, typically 1.0 mm in diameter, may be used with alignment pins (not shown) to reproducibly align metal housing 12 with other components of optical fiber array 10 or to reproducibly align optical fiber array 10 with another optical element or optical system.

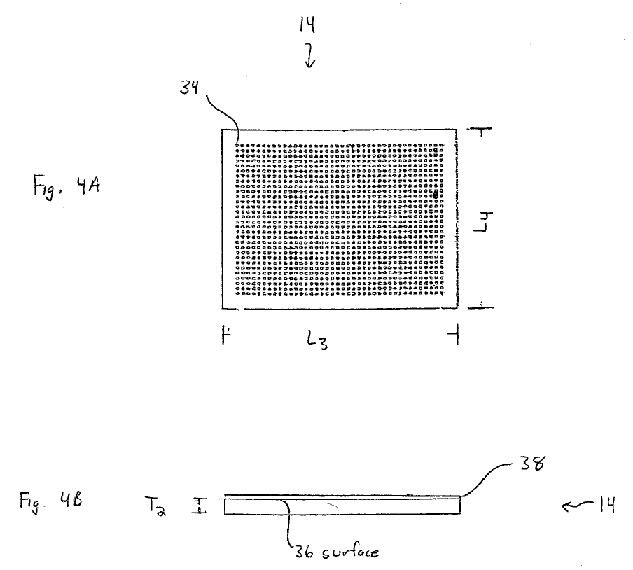

Metal plate 14 is shown in greater detail in FIGS. 4A-4B. In the illustrated embodiment, 1200 holes 34 (only one of which is labeled) arranged in a rectangular 30×40 array pass through metal plate 14. In the assembled optical fiber array 10, portions of optical fibers included in single-plane arrays 18-1-18-N will pass through holes 34 into matching holes in silicon plate 16 as described below. Each of holes 34 has a diameter of 0.45±0.05 mm and is separated from its nearest neighbor holes by 1.00 mm±0.01 mm. Other hole diameters and spacings may also be used. In this embodiment, metal plate 14 is conventionally machined from invar alloy (˜36% nickel, ˜64% iron) to have a rectangular shape with sides of length L₃=45.0 mm and L₄=35.0 mm and a thickness of T₂=3.0 mm Holes 34 are fabricated with conventional laser drilling techniques known to one of ordinary skill in the art. Such conventional laser drilling techniques allows precise positioning of holes having small diameters and high aspect ratios in an invar plate with noncumulative positioning error. Invar alloy was chosen because it has a coefficient of thermal expansion approximately equal to that of silicon.

Although FIGS. 4A-4B show 1200 holes 34 passing through metal plate 14, in other embodiments either more or fewer than 1200 such holes can be fabricated in metal plate 14. Also, though holes 34 are shown distributed in a particular pattern of rows and columns, other patterns may also be used. It should be understood that although in FIGS. 4A-4B metal plate 14 having holes 34 is shown in isolation, in the process described below for the assembly of fiber array 10 holes 34 are formed in metal plate 14 after metal plate 14 is attached to metal housing 12.

In one embodiment, a top surface 36 of metal plate 14 is coated with a layer 38 of soldering material during assembly of fiber array 10 (described below). In one implementation, layer 38 includes a 1000 microinch thick layer of nickel deposited on metal plate 14 and a 500 microinch thick layer of indium deposited on the nickel layer. Indium is chosen because it is a soft material that may be used as a solder at relatively low temperatures. The nickel and indium are deposited, for example, by conventional E-Ni electroless plating techniques known to one of ordinary skill in the art.

In the assembled optical fiber array 10 (FIG. 1), metal plate 14 attached to silicon plate 16 mechanically supports and reinforces silicon plate 16. Silicon plate 16 is thus prevented from bowing or otherwise distorting, particularly during polishing processes described below.

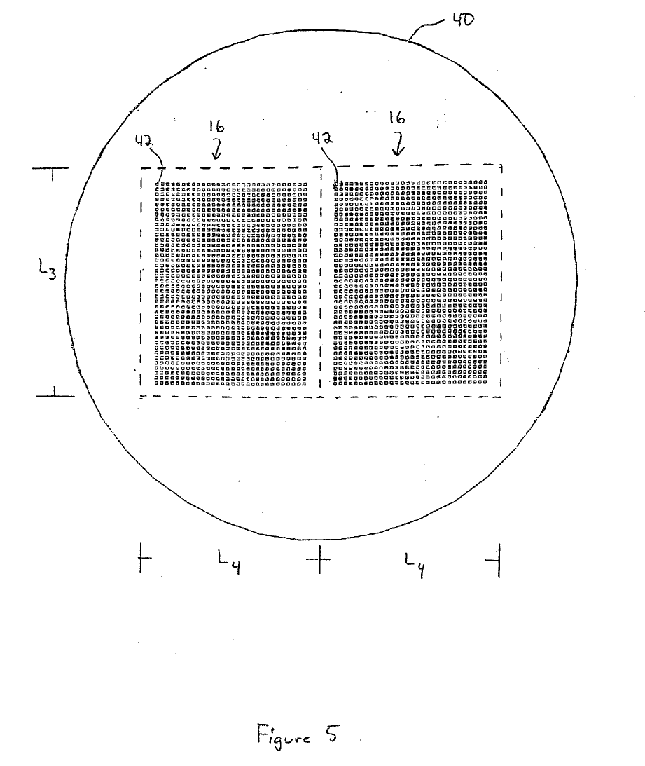

FIG. 5 is a schematic illustration of a silicon wafer 40 from which two silicon plates 16 may be fabricated. The dashed lines indicate the shapes of the finished silicon plates 16. In the illustrated embodiment, each silicon plate 16 is rectangular with sides of length L₃ and L₄ matching those of metal plate 14. A plurality of holes 42, arranged in a pattern matching that of the pattern of holes 34 in metal plate 14, pass through each silicon plate 16. Advantageously, silicon plates 16 may be batch fabricated by conventional processes (described below) known to one of ordinary skill in the art. Moreover, these known processes enable holes 42 having substantially parallel channels to be formed in silicon plate 16 with precise positions and diameters.

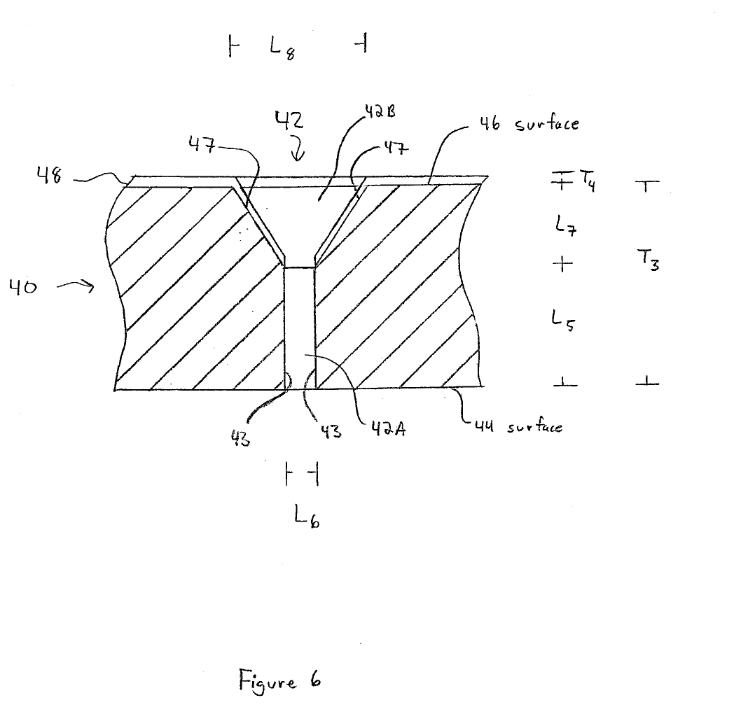

A cross-sectional view of a portion of silicon wafer 40 including one of the holes 42 is shown in FIG. 6. In this embodiment, silicon wafer 40 has a thickness of about T₃=700 μm. Holes 42 each include a straight-walled (e.g., cylindrical) channel portion 42A and a chamfered portion 42B. The walls 43 of the channel portions 42A of the various holes 42 are substantially parallel to one another. In particular, channel portions 42A typically deviate from parallel to one another by less than about 1 milliradian. In the illustrated embodiment, walls 43 of channel portions 42A are substantially perpendicular to front surface 44 of wafer 40. Other orientations of channel portions 42A with respect to surface 44 may also be used, however.

Channel portions 42A are fabricated with a conventional deep reactive ion etch (DRIE) process applied to front surface 44 of wafer 40. Such DRIE processes are known to one of ordinary skill in the art and need not be described in detail. In the illustrated embodiment, channel portions 42A are about L₅=400 μm long and have approximately round cross-sections in planes parallel to surface 44 with diameters of length about L₆=127 μm±1 μm. The magnitude of L₆ is typically chosen to be slightly greater than the diameters of the optical fibers that will subsequently be inserted into holes 42. The locations of the openings of channel portions 42A in surface 44 are typically known with a precision of better than about ±1 μm.

After the formation of channel portions 42A, an anisotropic potassium hydroxide (KOH) etch is applied to the back side 46 of silicon wafer 40 (the side opposite to front surface 44) to form chamfered portions 42B having side walls 47. Such anisotropic potassium hydroxide etching processes are known to one of ordinary skill in the art and need not be described in detail. In the illustrated embodiment, the depth of chamfered portions 42B is about L₇=300 μm. Chamfered portions 42B have approximately square cross-sections in planes parallel to surface 46 of silicon wafer 40. The sides of the square cross-sections increase in length as the locations of the cross-sections are moved toward surface 46. At surface 46, the sides of the square cross-sections of chamfered portions 42B typically have a length of about L₈=700 μm. Thus, holes 42 open out at the back side of silicon wafer 40 (and of silicon plate 16), allowing for easy insertion and self alignment of optical fibers into the channel portions 42A of holes 42. Typically, the side walls 47 of a chamfered portion 42B lead into a channel portion 42A without presenting any obstruction on which an optical fiber could catch during its insertion into the hole 42.

Other dimensions for silicon wafer 40, silicon plates 16, and portions 42A and 42B of holes 42 may also be used as appropriate. The thickness of silicon plate 16 and the dimensions of portions 42A and 42B of holes 42 are typically chosen to allow easy insertion of optical fibers and to maintain the orientations of the optical fibers to within about 1 milliradian of parallel. Typically, silicon wafer 40 and silicon plates 16 have a thickness T₃ greater than about 500 μm.

In one embodiment, a metal layer 48 is applied to surface 46 of silicon wafer 40 by sputtering, for example, after holes 42 are formed as described above. Metal layer 48 enables silicon plate 16 to be easily soldered to metal plate 14. In some implementations metal layer 48 extends into chamfered portions 42B of holes 42 to cover portions of side walls 47. In such implementations the portions of metal layer 48 on side walls 47 may facilitate formation of a hermetic solder seal between the optical fibers and silicon plate 16 during a subsequent soldering process. In some implementations metal layer 48 includes a layer of titanium about 500 Å thick deposited onto surface 46, a layer of nickel about 2000 Å thick deposited on the titanium, and a layer of gold about 2000 Å thick deposited on the nickel. Hence, in such implementations the total thickness of metal layer 48 is typically about T₄=4500 Å. Other combinations of metal layers that facilitate soldering of silicon plate 16 to metal plate 14 may also be used. In some implementations metal layer 48 also includes layers of nickel and indium applied by conventional electroless plating.

After fabrication of holes 42, silicon plates 16 may be separated from silicon wafer 40 by well known methods, typically by sawing or by scribing and cleaving, for example.

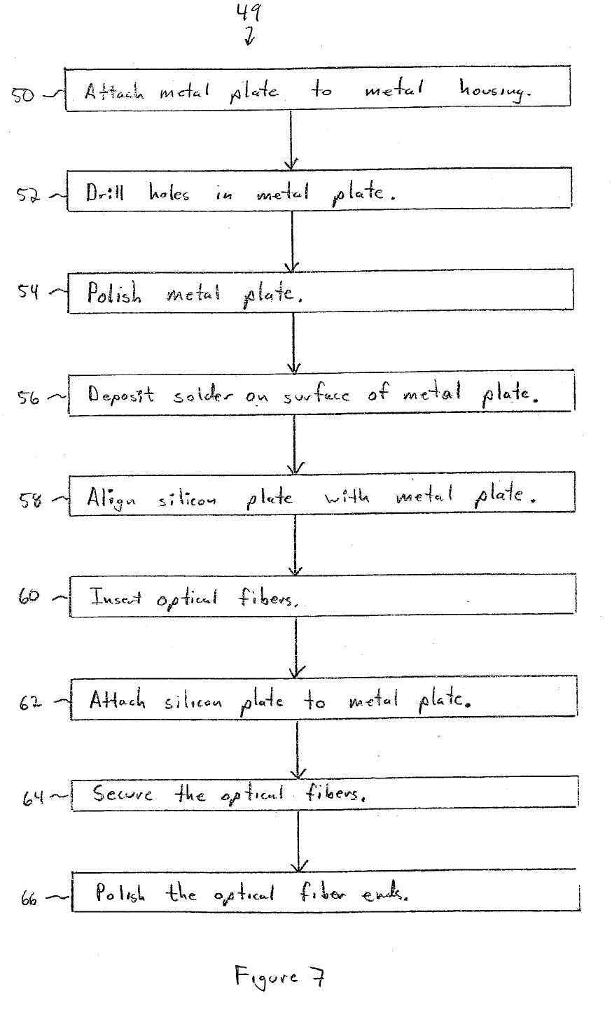

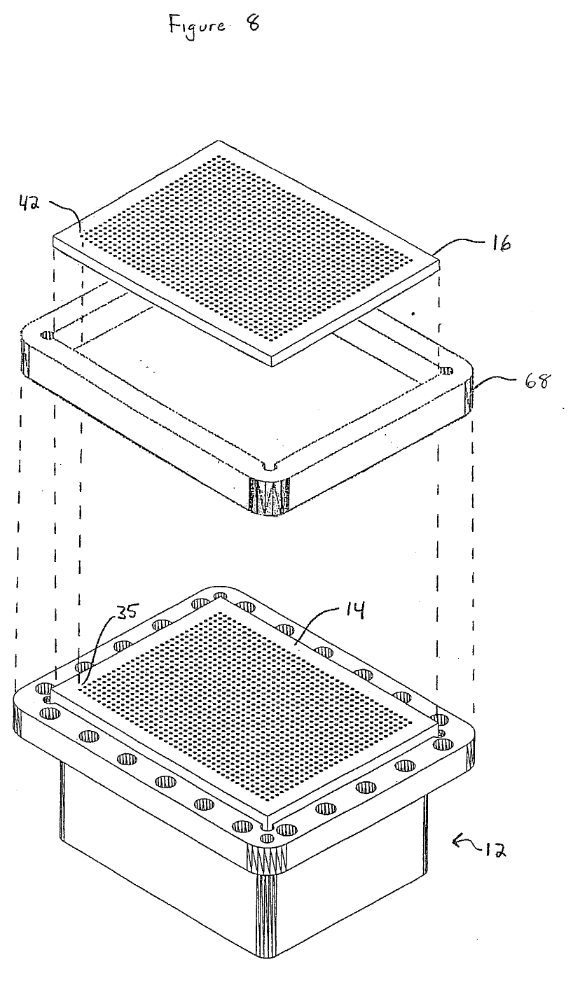

Referring to the flow chart shown in FIG. 7, optical fiber array 10 may be assembled from the components described above by the following method 49 in accordance with an embodiment of the present invention. First, in step 50, metal plate 14 is attached to metal housing 12. In the illustrated embodiment, metal plate 14 is seated in recess 28 of metal housing 12, as shown in FIG. 8, and conventionally brazed to surfaces of metal housing 12 that form recess 28. Next, in step 52, holes 34 are formed in metal plate 14 as described above. FIG. 8 shows the partially assembled optical fiber array resulting from step 52.

Next, in step 54, surface 36 of metal plate 14 (FIG. 4B) is polished to remove debris produced by the formation of holes 34. Typically, surface 36 is mechanically polished or lapped by conventional methods and then electropolished by conventional methods. Following step 54, in step 56 layer 38 of soldering material (e.g., nickel and indium layers as described above) is deposited on surface 36 by, for example, conventional electroless plating as described above.

Next, in step 58, silicon plate 16 is placed in contact with solder layer 38 on metal plate 14 and positioned such that holes 42 in silicon plate 16 are aligned with holes 34 in metal plate 14. In addition, silicon plate 16 is oriented such that metal layer 48 on silicon plate 16 faces solder layer 38 on metal plate 14 (FIG. 1). Such alignment of holes 42 with holes 35 may be accomplished with alignment ring 68 shown in FIG. 8. Alignment ring 68 is conventionally machined from stainless steel, for example, such that it can be fit around a portion of metal plate 14 protruding from metal housing 12 to temporarily hold silicon plate 16 in the desired position with respect to metal plate 14. In some implementations a conventional soldering flux is applied to metal layer 48 prior to assembly to facilitate a subsequent solder reflow process.

Following step 58, in step 60 a plurality of single-plane optical fiber arrays such as single-plane optical fiber array 18-1 of FIGS. 1 and 2A-2B are inserted into metal housing 12 such that free ends of the optical fibers (18g of FIGS. 2A-2B) pass through holes in metal plate 14 and corresponding holes in silicon plate 16 to protrude from silicon plate 16. The outer buffer layers of the optical fibers are removed to expose the clad layers of the free ends of the optical fibers prior to the insertion of the free ends into metal plate 14 and silicon plate 16. In some implementations the outer surfaces of the exposed clad layers of the free ends are metallized, as described above, prior to insertion. The optical fibers are easily installed by hand, for example. In the illustrated embodiment, 30 single-plane optical fiber arrays each including 40 optical fibers are inserted into metal housing 12. In this embodiment, the 40 optical fibers in a singe-plane array are inserted into separate holes 34 of the same column of 40 holes 34 in metal plate 14, and thus also into separate holes 42 of the same column of 40 holes 42 in silicon plate 16.

Following step 60, in step 62 silicon plate 16 is attached to metal plate 14. In the illustrated embodiment, metal plate 14 and silicon plate 16 are soldered together in a conventional indium solder reflow process which results in the indium of solder layer 38 adhering to metal layer 48 (FIGS. 1, 5, and 6). In some embodiments the indium may wet portions of the optical fibers (or metallization on the optical fibers) inserted into silicon plate 16 as well as side walls 47 (or metallization layer 48 on side walls 47) of chamfered portions 42B of holes 42 (FIG. 6). In such embodiments the solder may form hermetic seals between the optical fibers and silicon plate 16. After silicon plate 16 is attached to metal plate 14, alignment ring 62 may be removed.

After the optical fibers have been inserted into silicon plate 16 and silicon plate 16 has been attached to metal plate 14, in step 64 the optical fibers are secured in place in metal housing 12. In one embodiment, epoxy is injected into metal housing 12 by conventional methods known to one of ordinary skill in the art and then cured to immobilize the optical fibers. In some implementations the epoxy may penetrate holes 34 in metal plate 14 and enter portions of holes 42 in silicon plate 16.

In some embodiments, the order of steps 58 and 60 may be reversed. That is, silicon plate 16 may be attached to metal plate 14 prior to insertion of the optical fibers. In such embodiments, the fibers may be secured in metal plate 14 and silicon plate 16 by, for example, epoxy injected during step 64.

After the optical fibers have been secured in place, in step 66 portions of the optical fibers protruding from silicon plate 16 are polished flush with surface 20 (FIG. 1) by conventional mechanical polishing methods.

While the present invention is illustrated with particular embodiments, the invention is intended to include all variations and modifications falling with the scope of the appended claims. For example, although the number of holes for optical fibers in metal plate 14 is equal to the number of holes for optical fibers in silicon plate 16 in the illustrated embodiment, in other embodiments metal plate 14 and silicon plate 16 may have different numbers of holes for optical fibers. In such embodiments, the number of optical fibers used would typically be limited by the plate having the smaller number of holes for optical fibers. Moreover, though housing 12 and plate 14 have been described as being fabricated from metal, housing 12 and plate 14 may be formed from other materials such as ceramics and glasses in other embodiments. In addition, although the illustrated embodiments employ particular solder materials and particular metal layers, other solder materials and other metal layers may also be used.

We claim:

1. An apparatus comprising:
a housing;
a first plate through which pass a first plurality of holes distributed in a first pattern, said first plate attached to said housing;
a silicon plate through which pass a second plurality of holes distributed in a second pattern, said silicon plate attached to said first plate such that each of said second plurality of holes is substantially aligned with a corresponding one of said first plurality of holes; and
a plurality of optical fibers each of which passes through a corresponding one of said first plurality of holes and extends into a corresponding one of said second plurality of holes.

2. The apparatus of claim 1, wherein said housing is fabricated from a stainless steel.

3. The apparatus of claim 1, wherein said first plate is fabricated from an invar alloy.

4. The apparatus of claim 1, wherein said first plate is brazed to said housing.

5. The apparatus of claim 1, wherein a diameter of each of said second plurality of holes is approximately equal to a diameter of a corresponding one of said plurality of optical fibers.

6. The apparatus of claim 1, wherein portions of each of said second plurality of holes near said first plate are chamfered.

7. The apparatus of claim 1, further comprising a metal layer disposed on a surface of said silicon plate adjacent to said first plate.

8. The apparatus of claim 1, further comprising a layer of a soldering material disposed between said first plate and said silicon plate.

9. The apparatus of claim 8, wherein said soldering material forms a hermetic seal between said optical fibers and said silicon plate.

10. The apparatus of claim 8, wherein said soldering material comprises indium.

11. The apparatus of claim 1, further comprising an epoxy material that secures said optical fibers in said metal housing.

12. The apparatus of claim 1, wherein portions of said optical fibers are assembled into a plurality of substantially planar arrays each of which includes multiple optical fibers.

13. An apparatus comprising:
a stainless steel housing;
an invar alloy plate through which pass a first plurality of holes distributed in a first pattern, said invar alloy plate brazed to said metal housing;
a silicon plate through which pass a second plurality of holes distributed in a second pattern, each of said second plurality of holes including a chamfered portion and a channel portion, said silicon plate attached to said invar alloy plate such that each of said second plurality of holes is substantially aligned with a corresponding one of said first plurality of holes; and
a plurality of optical fibers each of which passes through a corresponding one of said first plurality of holes and extends into a corresponding one of said second plurality of holes.

14. A method of fabricating an optical fiber array, said method including:
attaching a first plate to a housing;
attaching a silicon plate to said first plate such that each of a first plurality of holes passing through said first plate is substantially aligned with a corresponding one of a second plurality of holes passing through said silicon plate; and
inserting each of a plurality of optical fibers into said housing, through a corresponding one of said first plurality of holes, and into a corresponding one of said second plurality of holes.

15. The method of claim 14, further comprising fabricating said housing from a stainless steel and fabricating said first plate from an invar alloy.

16. The method of claim 14, further comprising brazing said first plate to said housing.

17. The method of claim 14, further comprising soldering said first plate to a metal layer disposed on said silicon plate with a soldering material

18. The method of claim 17, wherein said soldering material comprises indium.

19. The method of claim 14, further comprising forming a portion of each of said second plurality of holes by deep reactive ion etching.

20. The method of claim 14, further comprising forming a chamfered portion of each of said second plurality of holes with a potassium hydroxide etch.

21. The method of claim 14, further comprising securing said optical fibers in said metal housing with an epoxy material.

22. The method of claim 14, further comprising polishing ends of said optical fibers to be substantially level with a surface of said silicon plate.

23. The method of claim 14, further comprising assembling said optical fibers into a plurality of substantially planar arrays prior to inserting said optical fibers into said housing.

24. An apparatus comprising:
a silicon plate through which pass a plurality of holes, said silicon plate having a first surface and a second surface, each of said holes having side walls;
wherein first portions of said side walls near said first surface are substantially parallel to each other, and second portions of said side walls near said second surface form chamfered openings in said second surface.

25. The apparatus of claim 24, wherein said silicon plate has a thickness greater than about 0.5 millimeters.

26. The apparatus of claim 24, wherein said first portions of said side walls form substantially cylindrical channels.

27. The apparatus of claim 24, wherein said chamfered openings have substantially square cross-sections.

28. The apparatus of claim 24, further comprising a metal layer disposed on said second surface.

29. An apparatus comprising:
a plurality of optical fibers each having a first portion and a second portion; and
an encapsulating material;
wherein said first portions of said optical fibers are encapsulated in said encapsulating material to form a sheet in which said first portions are substantially equally spaced and substantially parallel, and said second portions of said optical fibers are encapsulated in said encapsulating material to form a plurality of ribbons each of which includes a subset of said second portions of said optical fibers.

30. The apparatus of claim 28 wherein said sheet is substantially planar.

31. The apparatus of claim 28, wherein said sheet is flexible.

32. The apparatus of claim 28 wherein numerical apertures of said optical fibers vary by less than about 10% from the average value of the numerical apertures of said optical fibers.
